(19) United States
(12) Patent Application Publication
(10) Pub. No.: US 2017/0260339 A1
(43) Pub. Date: Sep. 14, 2017

(54) PROCESS AND SYSTEM FOR PRODUCING PET GRANULES

(71) Applicant: TECHNIP ZIMMER GMBH, Frankfurt am Main (DE)

(72) Inventors: Andreas BORMANN, Frankfurt (DE); Gerald KRIESCHE, Rodermark (DE); Michael REISEN, Frankfurt am Main (DE)

(21) Appl. No.: 15/327,854

(22) PCT Filed: Jul. 8, 2015
(86) PCT No.: PCT/EP2015/065631

§ 371 Date: Jan. 20, 2017

(30) Foreign Application Priority Data
Jul. 22, 2014 (DE) 10 2014 110 337.8

(51) Int. Cl. C08J 3/12; B29B 9/06; B29B 9/16

(52) U.S. Cl. CPC C08J 3/12; B29B 9/16; B29B 9/065; C08J 2367/02; B29K 2067/003

(57) ABSTRACT

A process and a system for producing polyethylene terephthalate (PET) granules by transesterification of dimethyl terephthalate with ethylene glycol or by esterification of (fiber) purified terephthalic acid with ethylene glycol suitable for further processing to form packaging films and bottles, comprising the steps of polycondensation, granulation and latent heat crystallization, aftertreatment of the crude granules to adjust the polymer quality values required for the further processing, in particular the intrinsic viscosity, the acetaldehyde content and the moisture content, wherein the aftertreatment is carried out in multiple moving bed tubular reactors operated in parallel.

### FIELD OF THE INVENTION

The invention relates to a process for producing PET (=polyethylene terephthalate) granules, suitable for further processing to produce packaging films and bottles, comprising the steps:
Producing a PET melt or PET copolyester melt in a single-line continuous polymerization system either by transesterification of dimethyl terephthalate (DMT) with ethylene glycol (EG) or by esterification of (fiber)-purified terephthalic acid (PTA) with ethylene glycol,
Transport of the PET melt to granulation through a pipeline, for example,
Granulation of the melt with cooling to form crude granules, wherein a partial crystallization of the polymer takes place with the release of some of the heat of crystallization of the polymer (latent heat crystallization),
Aftertreatment of the crude granules to adjust the polymer quality values required for further processing, in particular the intrinsic viscosity, the acetaldehyde content and the moisture content.

The invention thus relates to a system for carrying out the process.

### PRIOR ART

Process for producing PET granules, suitable for further processing to form packaging films and bottles are known in principle. The processes that can be used in the first step in which a polymer melt is produced from the basic materials DMT/EG or PTA/EG are described in Ullmann's Encyclopedia of Industrial Chemistry, 6^{th} edition, vol. 28, pages 238 to 240, for example. For the applications of packaging films and beverage bottles, the goal is an intrinsic viscosity of 0.75-0.84 dl/g in the melt produced. To establish certain properties, copolyesters are often used in addition to PTA and monoethylene glycol (MEG) consisting of 0 to 15% isophthalic acid and/or 0 to 2% diethylene glycol (DEG) and/or 0 to 5% 1,4-cyclohexane dimethanol (CHDM). This melt is conveyed from the polycondensation system through a pipeline into a system for producing and treating PET granules. The melt is extruded through a multihole nozzle in such a system, cooled with water and granulated by means of blades rotating directly on the nozzle plate. Then the water is removed from the granules so quickly, that only the superficial zone of the granules is quenched and enough heat remains in the core of the grains from the melt state, so that partial crystallization of the polymer takes place. This process is often referred to as the latent heat crystallization process. It is described in EP 1 608 696 B1, for example.

The partially crystalline granules are first poured into a container wherein the temperature of the granules is generally still above 160° C. The granules are then conveyed from the container into a moving bed tubular reactor for aftertreatment. Use of pneumatic conveyance has proven successful here. To prevent the granules from cooling, they are conveyed with heated air or heated inert gas accordingly.

The goal is for the granules to reach the moving bed tubular reactor that is used for the aftertreatment while the granules are still at a temperature of at least 160° C. The aftertreatment serves to adjust the intrinsic viscosity and/or to reduce the acetaldehyde content of the polymer and/or to adjust a defined moisture content according to the requirements of the further processing, for which the polymer is intended. Continuous processes, in which the granules have a countercurrent of a process gas flowing through them and a moving bed tubular reactor, have proven successful here.

To ensure the profitability of a production system that operates according to this process, it is necessary to design the system for the largest possible production capacity. As a result, only one product quality is produced at a time and it is necessary to carry out production in campaigns in order to be able to supply consumers with items of different product qualities. This in turn requires a large storage capacity for the end product and results in production of large quantities of waste when switching to a different product quality.

### DESCRIPTION OF THE INVENTION

The disadvantages of the prior art described here are avoided by a process and a system according to the features of the independent claims 1 and 9.

Process According to the Invention:

Process for producing polyethylene terephthalate (PET) granules suitable for further processing to form packaging film and bottles, comprising the steps:

a) Producing a PET melt or PET copolymer melt in a single-line continuous polymerization system, either by transesterification of dimethyl terephthalate (DMT) with ethylene glycol (EG) or by esterification of terephthalate acid (PTA) with ethylene glycol,

b) Transport of the melt preferably through a pipeline for further treatment in step c),

c) Granulation of the melt with cooling to form crude granules, wherein partial crystallization of the polymer takes place with the release of a portion of the heat of crystallization of the polymer (latent heat crystallization),

d) Aftertreatment of the crude granules to adjust the polymer quality values required for the further processing, in particular the intrinsic viscosity, the acetaldehyde and moisture content, characterized in that the aftertreatment takes place in multiple moving bed tubular reactors operated in parallel, wherein the dwell time of the granules in the reactor, the type and chemical composition of the process gas and its temperature and dew point at the entrance in to the reactor are adjusted individually for each one of the reactors.

System According to the Invention:

The system according to the invention comprises the following system parts:
a system part for producing a PET melt from the raw materials DMT/EG or PTA/EG,
a conveyor device for transporting the PET melt thus produced into the system for producing partially crystalline PET granules,
a system part for producing partially crystalline PET granules,
a conveyor device for the partially crystalline polymer granules,
at least two system parts for aftertreatment of the granules, each comprising a moving bed tubular reactor and devices for conveying, introducing and discharging the process gas.

Preferred embodiments of the invention are described in the dependent claims 2 through 7.

This invention allows to design the polymerization system that is required for process step a) of claim 1 producing continuously, requiring particularly high investment costs, with a single line and a large production capacity of, for example, 600 tons or even 1500 tons of polymer per 24 hours of operation. Such a polymerization system is usually designed as a reactor cascade with four or five reactors.

In this process step, polymer is produced in a basic quality, starting from which various end qualities that are customary on the market can be produced in the aftertreatment.

Coming from the last reactor of the polymerization system, the polymer melt is transferred to a granulation and crystallization system that operates according to the latent heat crystallization process.

Since the production capacity of these systems does not reach that of the large-scale polymerization systems, multiple granulation and crystallization systems are often operated in parallel. These systems convert the polymer melt extruded from a multihole nozzle into partially crystallized polymer granules.

The partially crystallized polymer granules are poured into a container from which they are sent to the fixed-bed shaft reactors set up in parallel for aftertreatment by means of a pneumatic conveyor system, for example.

One special embodiment of the invention consists of the polymerization of the PET taking place in step a) until establishing an intrinsic viscosity in the range of 0.70 to 0.80 dl/g. This establishes a basic quality of the polymer, on the basis of which the most customary final qualities for applications as beverage containers and packaging films can be produced in the aftertreatment.

Another specific embodiment of the invention consists in that the granulation and crystallization according to step c) of claim 1 take place in multiple lines wherein an additive is fed into the respective line to influence the polymer quality. The additive may be added, for example, to the corresponding pipeline. Likewise, in this way, a stream of recycled material can be fed into the process to work up production residues or prepurified, pulverized and melted PET bottle waste. The additives may be introduced into the PET stream either directly or embedded in a polymer matrix. Suitable additives include dye additives, for example, such as blue toner, phosphorus stabilizers to prevent yellowing of the PET, comonomers and/or acetaldehyde scavengers. The additives can be introduced into the PET stream either directly or embedded in a polymer matrix. Several polymer basic qualities can be produced in parallel with a low technical complexity in this way.

Another specific embodiment of the invention consists in that in step d) of claim 1, the aftertreatment of the crude granules is carried out in at least one of the moving bed tubular reactors with the goal of reducing the acetaldehyde content in the granules, wherein air at an inlet temperature between 160° C. and 200° C., preferably 180° C. and 190° C. is introduced into the reactor as the process gas. The latent-heat-crystallized granules enter the moving bed tubular reactor at a temperature of approximately 160° C., which the granules have retained from latent heat crystallization, so the granules need be heated by only a few ° C. for this aftertreatment. The dew point of the process gas is adjusted and monitored, so that the intrinsic viscosity of the polymer remains constant during this aftertreatment.

Another special embodiment of the invention consists in that in step d) of claim 1 the aftertreatment of the crude granules is carried out in at least one of the moving bed tubular reactors with the goal of increasing the intrinsic viscosity by up to 0.1 dl/g, using as process gas air at an inlet temperature between 160° C. and 190° C. into the reactor and a regulated dew point of less than −15° C.

Another special embodiment of the invention consists in that in step d) of claim 1 the aftertreatment of the crude granules takes place in at least one of the moving bed tubular reactors with the goal of increasing the intrinsic viscosity by more than 0.1 dl/g, wherein inert gas, preferably nitrogen, at an inlet temperature into the reactor between 150° C. and 230° C. and a dew point of less than −15° C. is used as the process gas. Because of the high process gas temperatures of more than 190° C. it is advisable to use oxygen-free process gas to prevent oxidative damage and the associated yellow coloration of the polymer. This process is also often referred to as solid phase condensation.

### Exemplary Embodiments

Additional features, advantages and possible applications of the invention are derived from the following description of one exemplary embodiment and the drawings. All the features described here and/or illustrated in the figures constitute the subject matter of the invention either alone or in any combination, regardless of how they are combined in the claims or in references back to previous claims.

The invention will now be explained in greater detail on the basis of the drawings, in which:

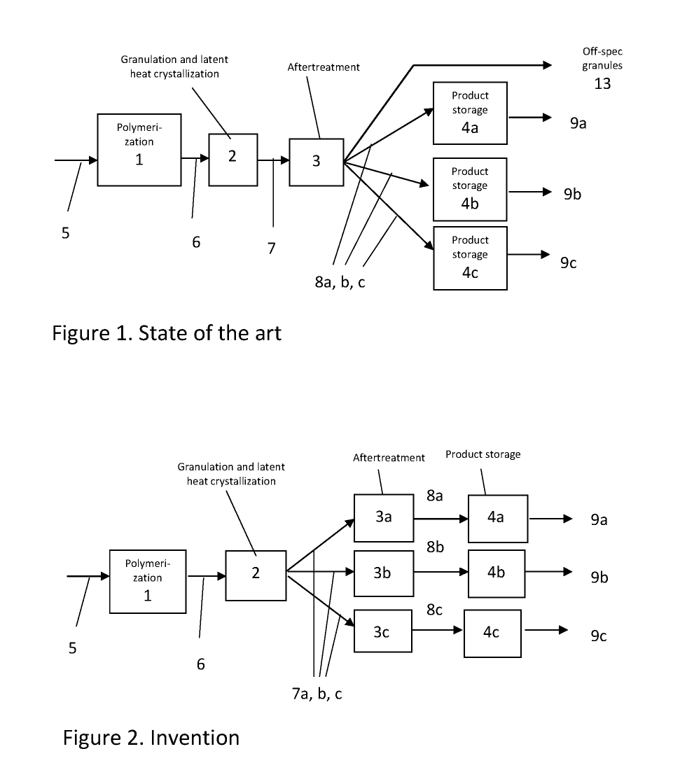

FIG. 1 shows a block diagram of a process and/or a system for producing aftertreated PET granules according to the prior art,

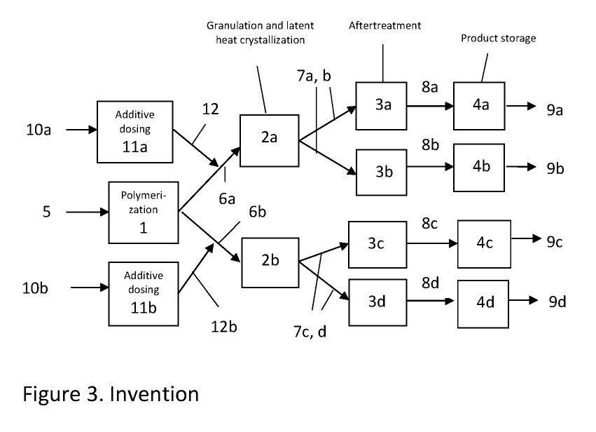

FIGS. 2 and 3 each show a block diagram of the process according to the invention and/or a system according to the invention.

FIG. 1 according to the prior art shows how starting materials 5, PTA/EG or DMT/EG are fed into the single-line continuously producing polycondensation system 1 and converted to a PET melt 6. The production capacity of system 1 is 600 tons of PET melt/day. It is not shown that the additives, for example, isophthalic acid and catalysts such as antimony, for example, that are needed to adjust the basic polymer quality in the melt 6 are used to make the polymer suitable for the production of beverage containers and packaging films. A suitable IV value (intrinsic viscosity) of the melt 6 for this purpose is 0.75 dl/g.

The term “quality” as used here and in the following is not to be understood in the sense of “good” or “bad” but rather in the sense of “type” or “grade.”

The melt 6 is transferred by means of a pump through a pipeline into a system for granulation and latent heat crystallization 2. The drawings do not show that this system includes two parallel production units for granulation and latent heat crystallization. In this system the PET melt is converted into partially crystalline PET granules. The granules are cooled to a temperature in the range of 160° C. to 180° C. The granules produced in the two units are transferred to a common container (not shown) and conveyed from there by a pneumatic conveyor 7 to the system 3 for the aftertreatment.

To avoid a loss of temperature by the granules, the pneumatic conveyance is accomplished using tempered gas accordingly.

The aftertreatment 3 is carried out according to the prior art in a continuous single-line system in campaigns, in which the system comprises a moving bed tubular reactor.

One aftertreatment process that is frequently used is dealdehydization, which serves to remove most aldehydes from the polymer. This is necessary in many cases when the polymer is to be processed to beverage bottles because aldehydes have a negative influence on the taste of the beverages. In this aftertreatment process, the dwell time of the granules in the moving bed tubular reactor is between 8 hours and 15 hours, or in many cases 12 hours. The process gas, whose temperature is adjusted so that the temperature of the granules is between 160° C. and 190° C., flows through the moving bed. In this temperature range, air is often used as the process gas.

Another aftertreatment process that is often used is to adjust a certain intrinsic viscosity. The change in intrinsic viscosity of the polymer in such a treatment is influenced by the moisture of the process gas. Table 1 shows this relationship as an example for a temperature and dwell time. In dealdehydization, the goal is to achieve a constant intrinsic viscosity and the dew point of the process gas is adjusted accordingly.

If the goal of the aftertreatment is a slight increase in the intrinsic viscosity, i.e., by at most 0.1 dl/g, then the procedure followed is the same. The dew point of the process gas is set lower accordingly.

The goal of the aftertreatment is often to raise the intrinsic viscosity of the polymer up to 0.95 dl/g as a result of the aftertreatment. In these cases it is favorable to keep the dwell time of the granules in the reactor within certain limits to adjust the temperature of the granules in the range of 200° C. to 230° C. It has proven suitable to use an inert gas such as nitrogen as the process gas in this temperature range. The dew point of the process gas is kept low accordingly as shown in Table 1.

TABLE 1
Change in the intrinsic viscosity Δ IV of the PET as a function
of the dew point of the process gas with a dwell time of 12 hours
and a temperature of the granules of 180° C.

| Δ IV (dl/g) | Dew point (° C.) |
|---|---|
| 0.08 | −40 |
| 0.05 | −30 |
| 0.03 | −20 |
| 0.00 | −15 |
| −0.05 | 0 |
| −0.09 | 10 |
| −0.1 | 20 |

The aftertreated PET granules are conveyed 8 into the product storage bin 4. The different polymer qualities produced are stored separately 4a, 4b, 4c. Since large quantities of granules, so-called off-spec quality, i.e., product that does not conform to specifications, are produced when switching an aftertreatment process to a different polymer quality, such changes are to be avoided as much as possible. Off-spec quality granules have only a very low market value and thus ultimately result in an increase in production costs. Off-spec granules 13 are usually bagged in shipping containers such as big bags directly from the aftertreatment reactor and then shipped off for further treatment.

To keep the frequency of changes in the aftertreatment process as low as possible, the production campaigns must be as long as possible so that a product storage site with a large holding capacity is required. This also increases the cost of production.

FIG. 2 illustrates how the production of off-spec granules can largely be prevented according to the invention and how such a process and/or such a system can be operated with a smaller product storage capacity.

FIG. 2 shows that the aftertreatment is carried out in several systems that are operated in parallel in this example for aftertreatment 3a, 3b, 3c. The systems 3a to 3c can be operated independently of one another so that three different polymer qualities 8a, 8b, 8c can be created at the same time from one basic quality 7a, 7b, 7c. The polymer qualities 8a through 8c are stored separately 4a, 4b, 4c and, as shown by the streams 9a, 9b, 9c, conveyed out of the respective storage for further processing. The product storage area may be designed to be smaller than that in the process according to FIG. 1 because now it is not the length of the production campaigns that is the relevant factor in designing the storage capacity but instead only the logistics of the further transport of the granules for further processing determine the size of the storage area.

FIG. 3 shows an example of one variant of the invention, in which the product quality can be altered in addition to being altered by the aftertreatment by feeding an additive into the polymer line 6a, 6b leading from the polycondensation system into the granulation system and thereby incorporating it into the polymer melt. This incorporation can take place by merely introducing the additive stream 12a, 12b into the polymer stream 6a, 6b or the mixing may be supported by mixers installed in the polymer line 6a, 6b.

For example, dye additives, such as so-called blue toners, stabilizers such as phosphorus compounds, diethylene glycol, IPA or other comonomers, aldehyde scavengers and recycled materials, i.e., shredded polymer material produced from used bottles, for example, may be considered as additives to be by from the dosing systems 11a, 11b into the polymer lines and/or polymer streams 6a, 6b by way of the lines 12a, 12b.

### LIST OF REFERENCE NUMERALS

1 Polymerization system

2a and b System for granulation and latent heat crystallization

3a to d System for aftertreatment

4a to d Storage for aftertreated granules

5 PTA/EG or DMT/EG

6a and b Transfer line for polymer melt

7a to d Pneumatic conveyance of the granules

8a to d Conveyance of the granules into the storage

9a to d Conveyance of the granules for further processing

10a and b Additives

11a and b System for dosing additives

12a and b Pipeline for feeding the additives into the transfer line

13 Off-spec granules

1. A process for producing polyethylene terephthalate (PET) granules suitable for further processing to form packaging film and bottles, comprising the steps:
a) Producing a PET melt or PET copolymer melt in a continuous single-line polymerization system, either by transesterification of dimethyl terephthalate (DMT) with ethylene glycol (EG) or by esterification of terephthalate acid (PTA) with ethylene glycol,
b) Transport of the melt preferably through a pipeline for further treatment in step c),
c) Granulation of the melt with cooling to form crude granules, wherein partial crystallization of the polymer takes place with the release of a portion of the heat of crystallization of the polymer (latent heat crystallization),
d) Aftertreatment of the crude granules to adjust the polymer quality values required for the further processing, in particular the intrinsic viscosity, the acetaldehyde and moisture content, characterized in that the aftertreatment takes place in multiple moving bed tubular reactors operated in parallel, wherein the dwell time of the granules in the reactor, the type and chemical composition of the process gas and its temperature and dew point at the entrance in to the reactor are adjusted individually for each one of the reactors.

2. The process according to claim 1, wherein the polycondensation of the PET takes place in step a) until establishing an intrinsic viscosity in the range of 0.70 to 0.80 dl/g.

3. The process according to claim 1, wherein step c) takes place in multiple lines, wherein an additive to influence the polymer quality or a stream of recycled material is fed into the respective line.

4. The process according to claim 1, wherein the additives added in step b) are introduced into the PET stream either directly or embedded in a polymer matrix.

5. The process according to claim 1, wherein the additives added in step b) are dye additives such as blue toners, phosphorus stabilizers to prevent yellowing of the PET, comonomers and/or acetaldehyde scavengers.

6. The process according to claim 1, wherein in step d) of claim 1 the aftertreatment of the crude granules takes place in at least one of the moving bed tubular reactors with the goal of reducing the acetaldehyde content in the granules, wherein air at an inlet temperature between 160° C. and 200° C., preferably 180° C. and 190° C. is introduced into the reactor as the process gas.

7. The process according to claim 1, wherein in step d) of claim 1, in at least one of the moving bed tubular reactors, the aftertreatment of the crude granules is carried out with the goal of increasing the intrinsic viscosity by up to 0.1 dl/g wherein air at an inlet temperature into the reactor between 160° C. and 190° C. and a dew point of less than −15° C. is used as the process gas.

8. The process according to claim 1, wherein in step d) of claim 1, in at least one of the moving bed tubular reactors, the aftertreatment of the crude granules is carried out with the goal of increasing the intrinsic viscosity by up to 0.1 dl/g wherein inert gas preferably nitrogen at an inlet temperature into the reactor between 150° C. and 230° C. and a dew point of less than −15° C. is used as the process gas.

9. A system for carrying out the process according to claim 1 comprising the following system parts:
a system part for producing a PET melt from the raw materials DMT/EG or PTA/EG,
a conveyor device for transporting the PET melt thereby produced into the system to produce partially crystalline PET granules,
a system part for producing partially crystalline PET granules,
a conveyor device for the partially crystalline polymer granules,
at least two system parts for aftertreatment of the granules, each comprising a moving bed tubular reactor and devices for conveying, introducing and discharging the process gas.
